(19) United States
(12) Patent Application Publication
(10) Pub. No.: US 2015/0158517 A1
(43) Pub. Date: Jun. 11, 2015

(54) Foldable Beverage Tray

(71) Applicant: Imtiaz Hasan, Schaumburg, IL (US)

(72) Inventor: Imtiaz Hasan, Schaumburg, IL (US)

(21) Appl. No.: 14/098,525

(22) Filed: Dec. 5, 2013

(51) Int. Cl. B62B 5/00; B65D 5/30

(52) U.S. Cl. CPC B62B 5/00; B65D 5/30

(57) ABSTRACT

The present invention provides a foldable beverage tray that starts as a flat planar surface and is then manipulated to take final foldable position that holds a beverage containers. The foldable beverage tray is affixed to a shopping cart, or other object, in order for patrons to utilize a shopping cart and enjoy a beverage at the same time. The foldable beverage tray comprises of a central panel, a first and second support panel hingedly affixed to the central panel, wherein the first and second support are further compromised of a first and second hanging member for securing the foldable beverage tray to an object. The first and second support panel are folded downward with respect to the horizontal central panel and taper downwards. A protrusion and notch found on the first support panel and second support panel, respectively, interlock the panels thereby creating a support base for resting of a beverage container

The present invention claims priority U.S. Provisional Patent Application No. 61/797,347 filed on Dec. 5, 2012, which is incorporate herein in its entirety.

### FIELD OF THE INVENTION

The present invention relates to an apparatus to provide the safe and cost-effective transportation of beverages in an environmentally friendly manner.

### BACKGROUND OF THE INVENTION

In hopes of expanding their market share, many food and beverage franchises have teamed up with large supermarket chains and department stores, opening beverage stalls within the supermarket premises. In addition, many grocery and department stores also encourage patrons to purchase beverages inside their physical stores. Consumers often fear spilling hot beverages while shopping. This fear is heightened when children are accompanying consumers. The physical challenges created by the handling of beverages while shopping precludes many consumers from purchasing beverages while shopping, resulting in decreases sales of beverages. Store owners and vendors have attempted to overcome the challenges consumers face to simultaneously handle and consume beverages while at the same time operating a shopping cart in department or grocery stores. The prior art discloses numerous solutions for reusable cup holders that affix to shopping carts.

U.S. Design Pat. Nos. D669,317 S and D632,930 S disclose designs for a cup holder. U.S. Pat. No. 4,957,253 discloses a baby bottle holder for attachment to solid support which cannot be stably affixed to a shopping cart.

In light of the shortcomings in the prior art, a beverage tray is desired that is functional, disposable or recyclable, and simple to use. The ideal beverage tray will be made of inexpensive material that may be recyclable or degradable such as cardboard, will have sufficient tensile strength, fit on the most prevalent shopping carts, require minimal manipulations by users to take final form to transport beverages, and The present invention solves these problems.

### SUMMARY OF THE INVENTION

The present inventions provides a foldable, biodegradable, recyclable, beverage tray that affixes to a shopping cart or any other support beam. The foldable beverage tray starts as a planar flat sheet of cardboard (or other fibrous material) that can be manipulated in a few movements to create an apparatus that can hold common coffee containers sizes such as the traditional 350 mL, 470 mL, and 710 mL sizes round at the leading coffee retailers. Other beverages that can be housed are common carbonated beverage cans, fountain drink cups, and glass bottles.

In the first embodiment, the foldable beverage tray is made from cardboard. B, C, or E flute cardboard may be used. The foldable beverage tray is comprised of a central panel having a planar surface, an upper surface, a lower surface, a left edge, a right edge, a rear edge, a front edge, and a beverage aperture. The foldable beverage tray has two support panels or flaps that extend from the central panel. In this first embodiment, a perforation, score-line or stamp provides flexibility between the central region and the support panels, allowing for downward folding of the support panels in relation to the central region. The first support panel has a proximal edge region and a distal edge region, wherein the proximal edge region is hingedly affixed to the left edge of the central panel, and wherein the first support panel further comprises a first hanging member. A second support panel has a proximal edge region and a distal edge region, wherein the proximal edge region is hingedly affixed to the right edge of the central panel, and wherein the second support panel further comprises a second hanging member. The central panel has a circular aperture extending therethrough from the upper surface to the lower surface so as to be able to receive a beverage container. The circular aperture has a top diameter of 7.5 cm, providing 2.0 cm of clearance for patrons to remove their cups. Other diameters may also be used. The first support panel has at least one or more protrusions on the distal edge region. The second support panel has a receiving aperture on the distal end region.

The mechanism of attaching the foldable beverage tray to a solid support beam of a shopping cart, or other structure, is placement of the support beam between a slit formed by the junction of the first and second hanging member and the area of the support panels facing the hanging members, known as the brace wall. The attachment point is a notch inside at the end of the slit provides a locking mechanism. The support beam takes a resting position inside the notch. In the first embodiment, the attachment point is designed to fit shopping carts with a wall thickness of between 3 to 7 mm, commonly found on wire-framed shopping carts found in most department stores such as Wal-Mart™, Whole Foods Inc.™, and all-plastic shopping carts commonly found in many Target™, department stores. The notch contains a protrusion designed to minimize movement the foldable beverage tray housing a beverage container.

The second support panel has an opening to receive and interlock with a protrusion on the distal edge of the first support panel. Once the support panels are manipulated downward by a consumer, the protrusion is inserted into the opening thereby locking the panels together and forming the final resting state of the foldable beverage tray.

To provide additional stability, the two side panels have apertures that have one or more walls. In the first embodiment, the apertures are square shaped and have four side walls. Upon interlocking the notch and protrusion, the distal most side walls of the aperture form a support base by coming together and allowing the bottom of a beverage container to take a resting position on the support base. It is not necessary that the bottom of a beverage container make contact with the support base in order for the foldable beverage tray to transport beverages. The foldable beverage tray may be placed at any location on the shopping cart and may extend inside or out of the walls. The brace wall of the support panel makes contact with the support beams of the shopping cart and thereby adds increased stability.

In another embodiment, the attachment point is designed to fit shopping carts with a wall thickness of between 17.00 mm and 17.58 mm.

In another embodiment, the foldable beverage tray has a horizontal panel, a circular aperture extending therethrough from the upper surface to the lower surface so as to be able to receive a frustoconical cup therein; and wherein the first and second support panels bend downwardly with respect to the horizontal panel; and wherein the stabilizing panel has two notches to receive the first and second tabs of the first and second support panels therethrough when bent downwardly to interlock the first and second support panels to the stabilizing panel; and wherein the first and second hooks can be removeably affixed to a rim of a shopping cart.

### BRIEF DESCRIPTION OF THE DRAWINGS

The features of this invention will be understood more fully and clearly apparent from the following description made in connection with the accompanying drawings wherein like reference numbers and characters refer to similar parts throughout the several views, and in which:

FIG. 1 is a partial isometric view of the foldable beverage tray and beverage in place resting on a 5 mm wall shopping cart support.

FIG. 1A is a top view of the foldable beverage tray.

FIG. 1B is an exploded view of a notch

FIG. 2 is a partial isometric view of the foldable beverage tray and beverage in place resting on a 17.5 mm wall plastic shopping cart support

FIG. 2A is a top side view of the foldable beverage tray with a 0.5 mm slit

FIG. 2B is an exploded view of a notch.

FIG. 3 is a partial isometric view of the box shelf beverage tray and beverage resting on a 5 mm wire-frame shopping cart support.

FIG. 3A is an exploded side view of the notch.

FIG. 3B is a top view of the box shelf beverage tray.

FIG. 4 is a partial isometric view of the box shelf beverage tray and beverage resting on a 17.5 mm wall all-plastic shopping cart support.

FIG. 4A is a top view of the box shelf beverage tray.

FIG. 4B is an exploded side-view of the notch.

### DETAILED DESCRIPTION OF THE INVENTION

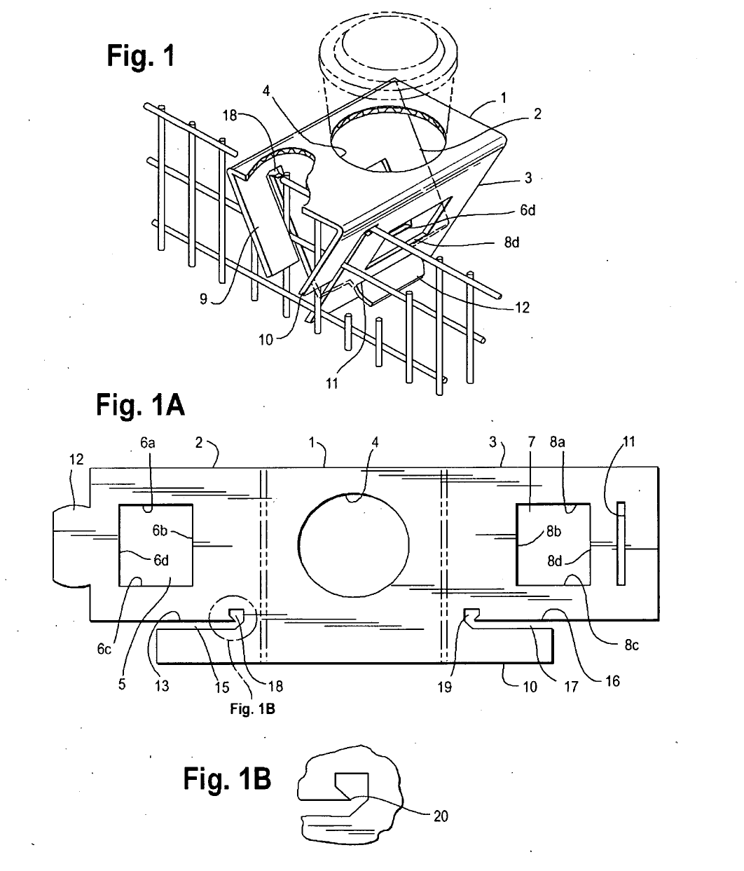

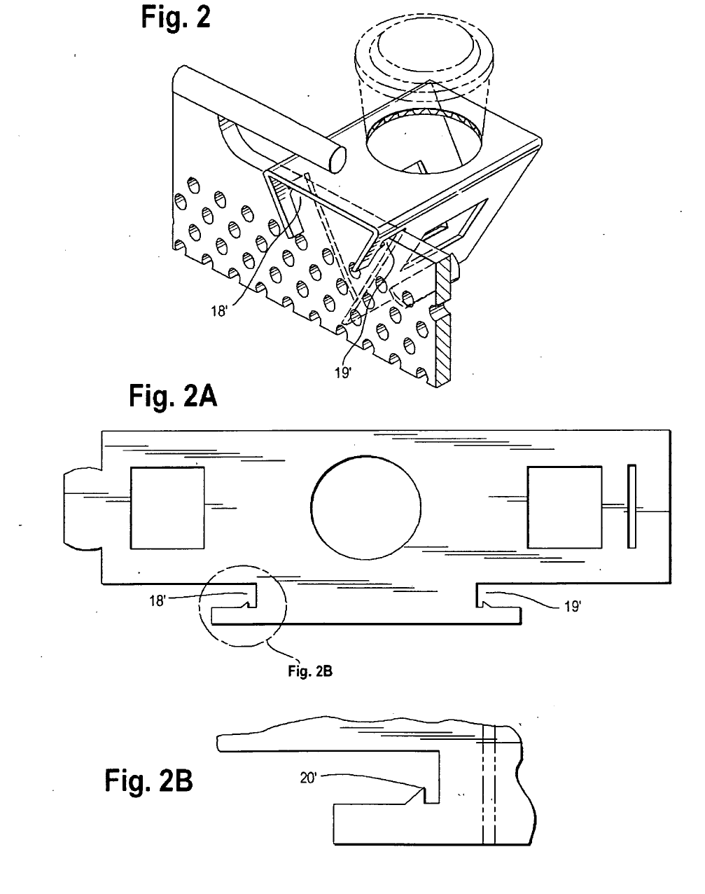

Turning to the drawings, and particularly FIGS. 1 through 1B, what is shown is a preferred first embodiment of the foldable beverage tray. The foldable beverage tray has a central panel 1, a first support panel 2, and a second support panel 3. A circular aperture 4 is located in the central panel 1. The first support panel 2 has a first aperture 5 with four side walls, 6a, 6b, 6c, and 6d. The second support panel 3 has a second aperture 7 with four side walls, 8a, 8b, 8c, and 8d. Further, the first support 2 panel has a first hanging member 9. The second support panel 3 has a second hanging member 10.

The second support panel 3 has a receiving aperture 11 that may be a slot, a circular opening, or of any dimension to accommodate the protrusion 12 found on the first support panel 2.

The insertion of the protrusion 12 into the receiving aperture 11 interlocks the two and results in the protrusion extending through the receiving aperture 11. The first support panel 2 and second support panel 3 are connected to the central panel 1 through a perforated, score-lined or stamped region, 21a on the first panel 2 and 21b on the second panel 3. The hanging member 9 and brace wall 13 form an elongated slit 15 on the first panel. The hanging member 10 of the second support panel 3 and brace wall 16 for an elongated slit 17. A support beam of a shopping cart is pushed through the elongated slits 15, 17 until the support beams reaches the first notch 18 of the first support panel and second notch 19 of the second support panel 3. The support beam takes a resting position in the first notch 18 and second notch 19.

The first support panel 2 has a distal most side wall 6d. The second support panel 3 has a distal most side wall 8d. When the first 2 and second support panels 3 are manipulated downward and the protrusion 12 is inserted through the receiving notch 11, the distal most side walls, 6d,8d, form a support base upon which a beverage may rest once inserted into the circular aperture 4. The notches 18,19, have a pointed protrusion 20 to secure a support beam in place.

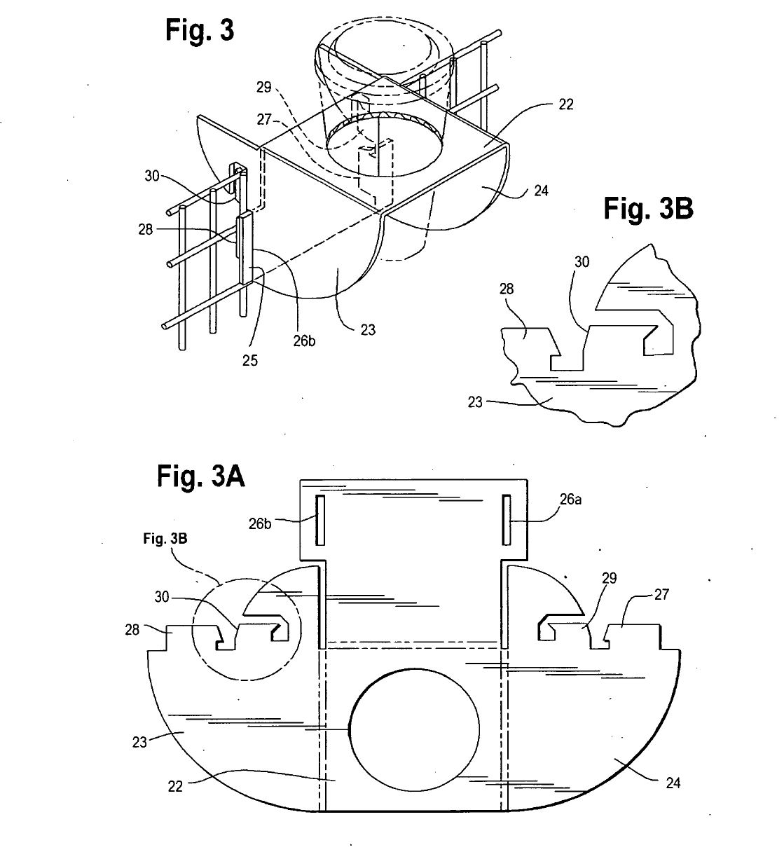

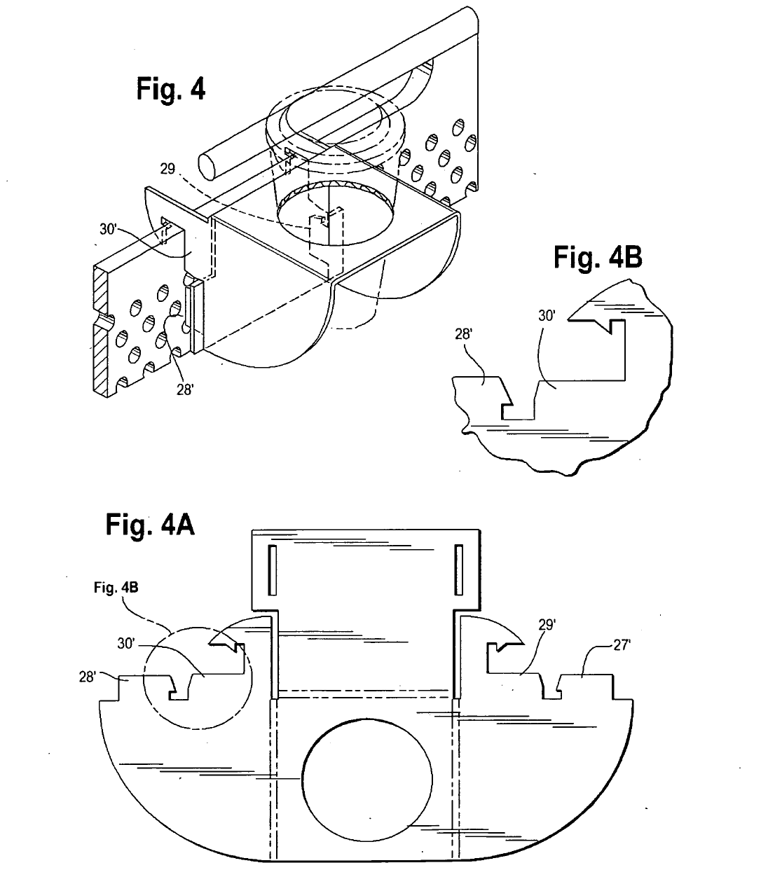

FIGS. 3 through 3B, what is shown is a second embodiment, the foldable beverage tray has a horizontal panel 22, a circular aperture extending therethrough from the upper surface to the lower surface so as to be able to receive a frustoconical cup therein; and wherein the first support panel 23 and second support panel 24 bend downwardly with respect to the horizontal panel 22; and wherein the stabilizing panel 25 has two notches, 26a,b to receive the first tab 27 and second tab 28 of the first and second support panels therethrough when bent downwardly to interlock the first and second support panels to the stabilizing panel; and wherein the first hook 29 and second hook 30 can be removeably affixed to a rim of a shopping cart.

What is claimed is:

1. A foldable beverage tray, comprising:
a central panel having a planar surface, an upper surface, a lower surface, a left edge, a right edge, a rear edge, a front edge, and a beverage aperture;
a first support panel having a proximal edge region and a distal edge region, wherein the proximal edge region is hingedly affixed to the left edge of the central panel, and wherein the first support panel further comprises a first hanging member;
a second support panel having a proximal edge region and a distal edge region, wherein the proximal edge region is hingedly affixed to the right edge of the central panel, and wherein the second support panel further comprises a second hanging member.

2. The foldable beverage tray of claim (1), wherein the central panel has a circular aperture extending therethrough from the upper surface to the lower surface so as to be able to receive a beverage container therein;

3. The foldable beverage tray of claim (2), wherein the first support panel has at least one or more protrusions on the distal edge region, wherein the second support panel has a receiving aperture on the distal end region.

4. The foldable beverage tray of claim (3), wherein the first hanging member extends from the central panel and forms a first slit, wherein the first slit further compromises of a notch for receiving and holding a support wherein the second hanging member extends from the central panel and forms a second slit, wherein the second slit further compromises of a notch for receiving and holding a support.

6. The foldable beverage tray of claim (5), wherein the first support panel has a first aperture, wherein the first aperture is defined by one or more side walls, wherein the distal wall from the aperture is a first support wall, wherein the second support panel has a second aperture, wherein the second aperture is defined by one or more side walls, wherein the distal wall from the aperture is a second support wall.

7. The foldable beverage tray of claim (6), wherein the first support panel and second support panel bend downward with respect to the central panel, wherein the first and second support panels form a pair of side walls, wherein the side walls taper down along the vertical axis, and wherein the receiving aperture of the second support panel receives the protrusion of the first support panel therethrough thereby interlocking the distal edge regions of the first and second support panels together.

8. The foldable beverage tray of claim (7), wherein the insertion of the protrusion into the receiving aperture forms a support base, wherein the support base is further compromised of the first and second support walls.

9. The foldable beverage tray of claim (8), wherein the foldable beverage container is affixable to a support by inserting the support into the slit; wherein the support takes a resting position in the notch.

10. The foldable beverage tray of claim (9), wherein a beverage container is placed inside the beverage aperture, wherein the beverage takes a resting position on the support base.

11. The foldable beverage tray of claim (10), wherein the beverage tray is made of a fibrous material.

12. The foldable beverage tray of claim (11), wherein the beverage tray is recyclable.

13. The foldable beverage tray of claim (9), wherein a beverage container is transported in a shopping cart by inserting the beverage container into the folded beverage container tray, wherein the shopping cart takes a resting position in the first notch of the first slit and the second notch of the second slit.

14. A foldable beverage tray, comprising:
a central panel having a planar surface, an upper surface, a lower surface, a left edge, a right edge, a rear edge, a front edge, and a beverage aperture;
a first support panel having a proximal edge region and a distal edge region, wherein the proximal edge region is hingedly affixed to the left edge of the central panel, and wherein the first support panel further comprises a first hanging member;
a second support panel having a proximal edge region and a distal edge region, wherein the proximal edge region is hingedly affixed to the right edge of the central panel, and wherein the second support panel further comprises a second hanging member, wherein
the central panel has a circular aperture extending therethrough from the upper surface to the lower surface so as to be able to receive a beverage container therein, wherein
the first support panel has at least one or more protrusions on the distal edge region, wherein the second support panel has a receiving aperture on the distal end region, wherein
the first hanging member extends from the central panel and forms a first slit, wherein the first slit further compromises of a notch for receiving and holding a support wherein the second hanging member extends from the central panel and forms a second slit, wherein the second slit further compromises of a notch for receiving and holding a support, wherein the first support panel has a first aperture, wherein the first aperture is defined by one or more side walls, wherein the distal wall from the aperture is a first support wall, wherein the second support panel has a second aperture, wherein
the second aperture is defined by one or more side walls, wherein the distal wall from the aperture is a second support wall, wherein
the first support panel and second support panel bend downward with respect to the central panel, wherein the first and second support panels form a pair of side walls, wherein the side walls taper down along the vertical axis, and wherein the receiving aperture of the second support panel receives the protrusion of the first support panel therethrough thereby interlocking the distal edge regions of the first and second support panels together, wherein
wherein the insertion of the protrusion into the receiving aperture forms a support base, wherein the support base is further compromised of the first and second support walls.

15. A foldable beverage tray, comprising:
a substantially horizontal panel having an upper surface, a lower surface, a left edge, a right edge, a rear edge and a front edge;
a first support panel having a proximal edge region and a distal edge region, wherein the proximal edge region is hingedly affixed to the left edge of the panel, and wherein the first support panel further comprises a first hook and a first tab on a rearward facing edge of the first support panel on the distal edge region;
a second support panel having a proximal edge region and a distal edge region, wherein the proximal edge region is hingedly affixed to the right edge of the panel, and wherein the second support panel further comprises a second hook and a second tab on a rearward facing edge of the second panel on the distal edge region;
a stabilizing panel having a proximal edge region and a distal edge region, wherein the proximal edge region is hingedly affixed to the rear edge of the panel.

16. The foldable beverage tray of claim (15), wherein the horizontal panel has a circular aperture extending therethrough from the upper surface to the lower surface so as to be able to receive a frustoconical cup therein; and wherein the first and second support panels bend downwardly with respect to the horizontal panel; and wherein the stabilizing panel has two notches to receive the first and second tabs of the first and second support panels therethrough when bent downwardly to interlock the first and second support panels to the stabilizing panel; and wherein the first and second hooks can be removeably affixed to a rim of a shopping cart.
